(19) United States
(12) Patent Application Publication
(10) Pub. No.: US 2009/0227194 A1
(43) Pub. Date: Sep. 10, 2009

(54) METHOD AND APPARATUS FOR CABIN AIR MANAGEMENT IN A VEHICLE

(76) Inventor: Vincent George Johnston, Oakland, MI (US)

Correspondence Address: SCHWEGMAN, LUNDBERG & WOESSNER, P.A., P.O. BOX 2938, MINNEAPOLIS, MN, 55402, US

(21) Appl. No.: 12/042,483

(22) Filed: Mar. 5, 2008

(51) Int. Cl. B60H 1/00

(52) U.S. Cl. 454/152; 415/203; 416/1

(57) ABSTRACT

One embodiment includes an apparatus for a vehicle that includes a heating, ventilation and air conditioning (“HVAC”) shell having a plurality of openings therein, a fluid distribution ring mounted for coaxial rotary movement within the HVAC shell, the fluid distribution ring having one or more apertures therein to align with the plurality of openings in the shell to put openings in fluid communication with an inner chamber and a mechanism coupled to the HVAC shell and the fluid distribution ring to rotate the ring relative to the HVAC shell between selected rotary positions to provide fluid flow paths through the inner chamber and those openings in the HVAC shell that are aligned with the one or more apertures in the fluid distribution ring.

### BACKGROUND

Climate control is important in vehicles such as automobiles. These systems affect comfort, energy efficiency, and perceived value for the customer. For example, consumers perceive improved adjustability as a feature that can provide comfort and that can merit a higher vehicle price.

Since manufacturers and consumers are cost conscious, systems that provide for lower cost are desired. Variables that affect systems, apparatus and methods related to climate control include cost to build, energy efficiency during operation, part weight, part size and reliability. Improving the performance of systems, apparatus and methods to impact these variables can lower costs and otherwise improve customer satisfaction.

### BRIEF DESCRIPTION OF THE DRAWINGS

FIG. 1 is a high level diagram of a vehicle, according to some embodiments.

FIG. 2 shows an exploded perspective view of a portion of a heating, ventilation and air conditioning unit, according to some embodiments.

FIG. 3 shows an assembled perspective view of the parts illustrated in FIG. 2.

FIG. 4A shows a cross section of a shell and a fluid distribution unit, according to some embodiments.

FIG. 4B shows a cross section of a shell and a fluid distribution unit, according to some embodiments.

FIG. 4C shows a cross section of a shell and a fluid distribution unit, according to some embodiments.

FIG. 4D shows a cross section of a shell and a fluid distribution unit, according to some embodiments.

FIG. 4E shows a cross section of a shell and a fluid distribution unit, according to some embodiments.

FIG. 4F shows a cross section of a shell and a fluid distribution unit, according to some embodiments.

FIG. 4G shows a cross section of a shell and a fluid distribution unit, according to some embodiments.

FIG. 4H shows a cross section of a shell and a fluid distribution unit, according to some embodiments.

FIG. 4I shows a cross section of a shell and a fluid distribution unit, according to some embodiments.

FIG. 5 is a diagram showing opening orientation in a shell, according to some embodiments.

FIG. 6 is a diagram showing aperture orientation in a fluid distribution ring, according to some embodiments.

FIG. 7 illustrates a flow chart, according to some embodiments.

### DETAILED DESCRIPTION

In the following description, reference is made to the accompanying drawings that form a part hereof, and in which is shown by way of illustration, specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Heating, ventilation and air conditioning (“HVAC”) fluid handling systems, apparatus and methods blow fluid around the interior of a cabin. In some examples, the fluid is air. In various embodiments, the fluid originates from outside the cabin, from inside the cabin, or originates from a mix of sources including the inside of the cabin and the outside of the cabin. Some examples include a filter to filter the air by removing particulates from the air. In various embodiments, the present subject matter is adapted to control climate in a cabin of a vehicle. Although the present subject matter recites HVAC, the present subject matter is not limited to embodiments including air conditioning.

In some instances, fluid is routed through baffles and/or blend doors to a number of vents. In some embodiments, vents are easily accessed by users such as persons driving or riding in a vehicle. Users can adjust vents in some examples, either adjusting the direction of fluid flow, or whether or not fluid flows through the vent. In some examples, vents are not easily accessible to users. In some of these examples, a vent directs fluid flow without input from a user. Examples of such vents include floor vents and defrost vents.

It is beneficial to reduce or eliminate blend doors and baffles, to reduce cost and improve reliability and performance. Elimination of one blend door from a system can reduce the number of associated adjustment mechanisms, such as adjustment cables, motor drives or other hardware and electronics. Further, if obstructions in fluid flow, such as blend doors and baffles, are reduced or eliminated, smaller fluid collecting and moving sources, such as exterior openings and blower motors, can be used. Reduction of such obstructions can additionally decrease noise. Simplified HVAC systems can provide for shorter development times, since temperature control, noise control, energy consumption, and other design objectives are more easily met.

The present subject matter reduces pressure loss by reducing or eliminating blend doors. In some embodiments, the present subject matter provides for independent temperature control of fluid passing through two or more vents. The present subject matter provides for a reduction in pressure loss and reduces the noise and power consumption required to drive the airflow, in various embodiments. The present subject matter additionally reduces weight, as some embodiments reduced the number of baffles, blend doors, and associated devices used to control fluid flow. An added benefit of the present subject matter is that it provides occupants with an improved variety of fluid distribution and temperature settings. The present subject matter is applied to vehicles having 1 seat, one row of seats (e.g., 2 seats), 2 rows of seats (e.g., 4 seats), 3 rows of seats (e.g. 6 seats) and additional configurations.

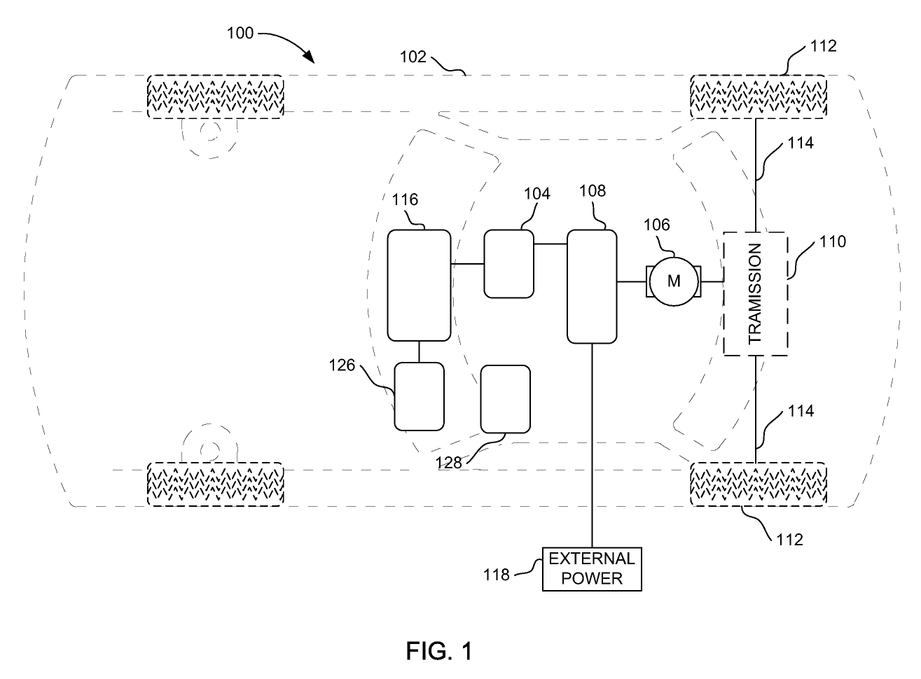

FIG. 1 is a high level diagram of a system 100. Vehicles contemplated include, but are not limit to, ground based vehicles, aquatic vehicles, and aircraft. The present subject matter includes, but is not limited to, electric vehicles, hybrid vehicles having series hybrid architecture (e.g., range extended vehicles), vehicles having parallel hybrid architecture and other vehicles. In various embodiments, the vehicle 102 includes a battery 104 and electric motor 106 coupled to propel the vehicle 102, the battery 104 coupled to power the electric motor 106. In various examples, the electric motor 106 is for converting battery energy of the battery 104 into mechanical motion, such as rotary motion. Some examples include components coupled to a battery 104 such that the battery 104 can be plugged in for charging, using energy from another source such as a municipal power grid.

The present subject matter includes examples in which the battery 104 is a subcomponent of an energy storage system (“ESS”). An ESS includes various components associated with transmitting energy to and from the battery 104 in various examples, including safety components, cooling components, heating components, rectifiers, etc. The inventors have contemplated several examples of ESSs and the present subject matter should not be construed to be limited to the configurations disclosed herein, as other configurations of a battery 104 and ancillary components are possible.

Various battery chemistries are contemplated for battery 104. The present subject matter includes embodiments in which the battery 104 is a secondary battery that is rechargeable using electricity rather than chemicals or other materials. Various secondary battery chemistries are contemplated for battery 104, including lithium ion battery chemistries, lithium cobalt oxide cells, lithium iron phosphate battery chemistries, nickel metal hydride chemistries, lead acid chemistries, and other chemistries.

In some examples, the battery 104 includes a plurality of lithium ion cells coupled in parallel and/or series. Some examples of battery 104 include cylindrical lithium ion cells. In certain examples, the battery 104 includes one or more cells compatible with the 18650 battery standard, but the present subject matter is not so limited. Some examples include a first plurality of cells connected in parallel to define a first brick of cells, with a second plurality of cells connected in parallel to define a second brick of cells, with the first brick and the second brick connected in series. Some examples connect 69 cells in parallel to define a brick. Battery voltage, and as such, brick voltage, often ranges from around 3.6 volts to about 4.2 volts in use. In part because the voltage of batteries ranges from cell to cell, some instances include voltage management systems to maintain a steady voltage. Some embodiments connect 9 bricks in series to define a sheet. Such a sheet has around 35 volts. Some instances connect 11 sheets in series to define the battery of the ESS. The ESS will demonstrate around 385 volts in various examples. As such, some examples include approximately 6,831 cells that are interconnected.

Additionally illustrated is an energy converter 108. The energy converter 108 is part of a system which converts energy from the battery 104 into energy useable by the electric motor 106. In certain instances, the energy flow is from the electric motor 106 to the battery 104. As such, in some examples, the battery 104 transmits energy to the energy converter 108, which converts the energy into energy usable by the electric motor 106 to propel the vehicle 102. In additional examples, the electric motor 106 generates energy that is transmitted to the energy converter 108. In these examples, the energy converter 108 converts the energy generated by the electric motor 106 into energy which can be stored in the battery 104. In certain examples, the energy converter 108 includes transistors. Some examples include one or more field effect transistors. Some examples include metal oxide semiconductor field effect transistors. Some examples include one more insulated gate bipolar transistors. As such, in various examples, the energy converter 108 includes a switch bank which is to receive a direct current (“DC”) power signal from the battery 104 and to output a three-phase alternating current (“AC”) signal to power the electric motor 106. In some examples, the energy converter 108 is to convert a three phase signal from the electric motor 106 to DC power to be stored in the battery 104. Some examples of the energy converter 108 convert energy from the battery 104 into energy usable by electrical loads other than the electric motor 106. Some of these examples switch energy from approximately 390 Volts DC to 14 Volts DC.

The electric motor 106 is, in some embodiments, a three phase alternating current (“AC”) electric motor. Some examples include a plurality of such motors. The present subject matter can optionally include a transmission 110 in certain examples. While some examples include a 1-speed transmission, other examples are contemplated, including a 2-speed transmission, and transmissions having more than 2 speeds. In some examples, manually clutched transmissions are contemplated, as are those with hydraulic, electric, or electrohydraulic clutch actuation. Some examples employ a dual-clutch system that, during shifting, phases from one clutch coupled to a first gear to another coupled to a second gear. Rotary motion is transmitted from the transmission 110 to wheels 112 via one or more axles 114, in various examples.

A vehicle management system 116 is optionally provided to control one or more of the battery 104 and the energy converter 108. In certain examples, the vehicle management system 116 is coupled to vehicle system which monitors a safety system such as a crash sensor. In some examples the vehicle management system 116 is coupled to one or more driver inputs, such as acceleration inputs. The vehicle management system 116 is to control power to one or more of the battery 104 and the energy converter 108, in various embodiments.

External power 118 is provided to communicate energy with the battery 104, in various examples. In various embodiments, external power 118 includes a connector that is coupled to a municipal power grid. In certain examples, the charging converts power from an 110V AC power source into power storable by the battery 104. In some examples, such conversion is performed by components onboard of a vehicle. In additional examples, the connector converts power from a 120V AC power source into power storable by the battery 104. Some embodiments include converting energy from the battery 104 into power usable by a municipal grid. The present subject matter is not limited to examples in which a converter for converting energy from an external source to energy usable by the vehicle 102 is located outside the vehicle 102, and other examples are contemplated.

Some examples include a vehicle display system 126. The vehicle display system 126 includes a visual indicator of information relating to the system 100 in some examples. In some embodiments, the vehicle display system 126 includes a monitor that includes information related to the system 100. The vehicle display system can include a user interface relating to HVAC as disclosed herein.

Various embodiments include an HVAC 128 as described herein. The HVAC 128 can receive heat from an engine in some embodiments. In additional embodiments, the HVAC 128 uses electricity, such as from battery 104, to provide heat.

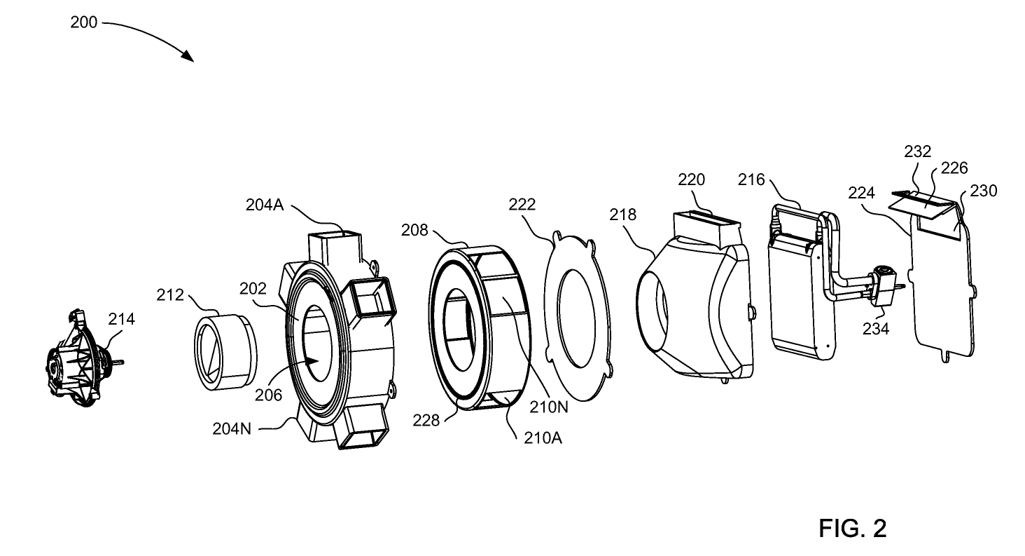

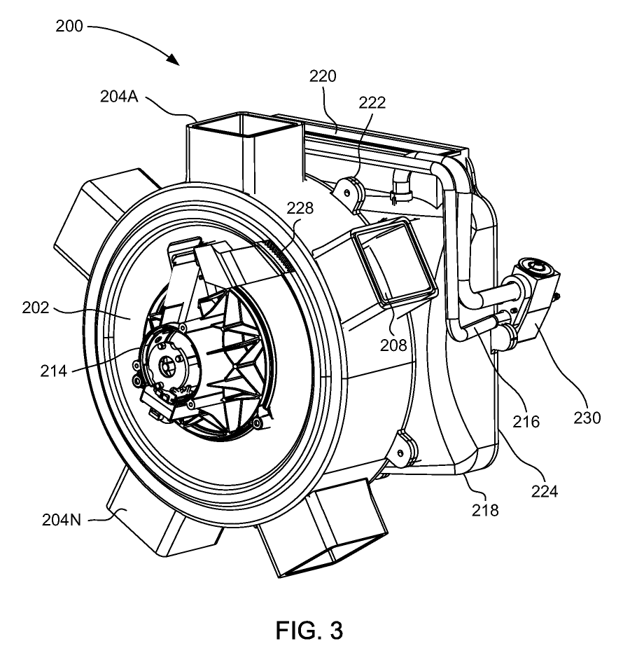

FIG. 2 is an exploded perspective view of a portion of an HVAC system 200, according to some embodiments. FIG. 3 shows an assembled perspective view of the parts illustrated in FIG. 2. Various embodiments include an HVAC shell 202. In various embodiments, the HVAC shell 202 includes a plurality of openings 204A-N. In various embodiments, the plurality of openings 204A-N are in fluid communication with an inner chamber 206. The HVAC shell 202 can be constructed from various materials, including, but not limited to, plastics such as ABS, composites such as fiberglass and carbon fiber. Other materials and combinations of materials are additionally possible.

Various embodiments include a fluid distribution ring 208. In various embodiments, the fluid distribution ring 208 is mounted for coaxial rotary movement within the HVAC shell 202. In some embodiments, the fluid distribution ring 208 is concentric with the HVAC shell 202. Some embodiments include an HVAC shell cover 222 to seal the fluid passing into the fluid distribution ring 208. The fluid distribution ring 208, in various examples, includes one or more apertures 210A-N.

Various embodiments include a mechanism coupled to the HVAC shell 202 and the fluid distribution ring 208 to rotate the ring relative to the HVAC shell between selected rotary positions to provide fluid flow paths through those openings 204A-N in the HVAC shell that are aligned with the one or more apertures 210A-N in the fluid distribution ring 208. In various embodiments, the mechanism includes a worm drive. In various embodiments a worm drive includes a worm gear mated to teeth 228 to move the teeth 228 relative to the worm gear. The present subject matter additionally includes other drive systems to change the orientation of the fluid distribution ring 208 with respect to the HVAC shell 202.

In various embodiments, the plurality of openings 204A-N and apertures 210A-N have a circular cross-section. In some embodiments, the plurality of openings 204A-N and apertures 210A-N are like sized. Embodiments in which apertures 210A-N are shaped differently from the plurality of openings 204A-N are contemplated. Regular shapes and irregular shapes in addition to circular shapes are possible for each of the plurality of openings 204A-N and apertures 210A-N. The present configuration is provided for explanation, and should not be construed as limiting of the possible configurations.

The depth of one or more of the HVAC shell 202 and the fluid distribution ring 208 are adjustable depending on fluid volume required for an application. Airflow can additionally be adjusted by varying the size of one or more of the plurality of openings 204A-N and apertures 210A-N. Diameter likewise can impact the volume of fluid passing through the system 200. Embodiments disclosed herein include one or more modes in which an opening of the plurality of openings 204A-N is coextensive with an aperture of the apertures 210A-N, but the present subject matter includes embodiments in which an aperture of the apertures 210A-N is only partially mated with an opening of the plurality of openings 204A-N. The present subject matter provides for adjustability of airflow and temperature by varying the degree to which an aperture of the apertures 210A-N and an opening of the plurality of openings 204A-N are aligned in some embodiments. The specific location of openings 204A-N and apertures 210A-N is not limited to those orientations provided herein, and additional orientations are possible.

Various embodiments include a blower 212. In various embodiments, the blower is concentric with one or more of the HVAC shell 202 and the fluid distribution ring 208, but the present subject matter is not so limited. In various embodiments, the blower 212 is located upstream of the evaporator 216. The blower 212 is not limited to a concentric orientation with the HVAC shell 202. Additionally illustrated is a blower motor 214. In various embodiments, the blower 212 is spun by the blower motor 214 to force fluid from the inner chamber 206 through those of the plurality of openings 204A-N in the HVAC shell 202 that are aligned with the one or more apertures 210A-N in the fluid distribution ring 208. In various embodiments, the blower 212 is coupled to a vehicle, such as the vehicle associated with FIG. 1. Blower types include, but are not limited to, fans, radial fans, axial fans, fans including a shroud, squirrel cages, and other fans. In some embodiments, the blower motor 214 is a variable speed blower motor. In some instances, motor speed is controlled via switching one or more resistors into and out of series with a voltage to supply a plurality of voltages to the blower motor 214 according to several embodiments. In additional examples, motor speed is controlled via pulse width modulation of a voltage supplying energy to the blower motor 214. Additional control configurations are also possible. The size of blower 212 is selected to fit various applications. For example, diameter and width are variable depending on the volume or air that is desired to flow over time.

Various embodiments include a heat exchanger such as evaporator 216. Additionally illustrated is a thermal expansion valve 234. In various embodiments, the evaporator 216 is coupled to contact fluid passing through those openings of the plurality of openings 204A-N in the HVAC shell 202 that are aligned with the one or more apertures 210A-N in the fluid distribution ring 208. In various embodiments, fluid is drawn through the evaporator 216 and the evaporator 216 extracts heat and condenses moisture from the incoming fluid. In various examples, the evaporator 216 dehumidifies fluid.

Various embodiments include an evaporator housing 218 (also referred to as a heat exchanger housing) coupled to the evaporator 216 to constrain fluid flow from an inlet 220 of the evaporator housing 218 to the inner chamber 206. In various embodiments, the evaporator housing 218 is coupled to a vehicle such as the vehicle illustrated in FIG. 1, and the inlet 220 is inside a cabin of the vehicle. Some embodiments include an evaporator housing cover 224 to seal fluid into the evaporator housing 218. In various embodiments, the inlet 220 is adapted to switch between or blend between a recirculating fluid inlet 230 and a fresh fluid inlet 232. In various embodiments, switching is assisted by an inlet blend door 226. In various embodiments, in a fresh fluid mode, the inlet blend door 226 is adjusted to direct fluid from outside of the vehicle into the inner chamber 206. In additional embodiments, in a recirculating fluid mode, the inlet blend door 226 is adjusted to direct fluid from inside a cabin of a vehicle into the inner chamber 206.

Various embodiments include a heat exchanger that includes a heating element. The evaporator 216 in some embodiments is coupled with a heating element, such as a heater core or an electronic heating element. Heating and cooling can be provided alone or in combination. Some examples include positive temperature coefficient (“PTC”) heat exchangers to provide heating. In some embodiments, a single PTC heater is disposed proximal to the evaporator 216, such as downstream of the evaporator 216. In some of these embodiments, the PTC heater is disposed in the evaporator housing 218. Some embodiments include a temperature blend door to regulate the amount of total airflow through the heater. Some embodiments include a PTC heater that uses between 3 and 5 kW, but the present subject matter is not so limited. Additional embodiments position a heat exchanger such as a PTC heater in one or more of the plurality of openings 204A-204N. In some embodiments, these heat exchangers each use from 0 to 1 kW during heating, but the present subject matter is not so limited. In still further embodiments, heat exchangers are positioned proximal to vents that are coupled to the plurality of openings 204A-204N, such as through ductwork. Various embodiments include a heat exchanger housing for one or both of an evaporator 216 and a heating element.

The heating, ventilation and system 200, in various embodiments, include ducts. Ducts are attached to the plurality of openings 204A-N in the HVAC shell 202. Ducts extend around a vehicle, in various examples. In some examples, ducts exit near the driver window (e.g. the left front window), the front passenger window (e.g. the right front window), near the floor of the driver and the front passenger, and in some embodiments near the floor of rear occupants. In some embodiments, a valve is coupled to at least one of the plurality of openings 204A-N in the HVAC shell 202 to further control airflow. Such a valve can include a manual flute coupled to a vent that is flush mounted with an instrument panel, but the present subject matter is not so limited. These configurations are provided for illustration, and the present subject matter includes additional configurations. In various embodiments, one or more ducts include temperature sensors that relay temperature information to a controller controlling one or more of the blower motor 214, a mechanism to adjust orientation of the fluid distribution ring 208 with respect to the HVAC shell 202, and one or more secondary heat exchangers.

Control of the system 200 is accomplished according to several configurations, including manual configurations and automatic configurations. Various embodiments allow a user to input a desired temperature change from the driver position. In some embodiments, temperature control is determined by occupant demand, and regulated via an electronic automatic temperature control (“EATC”) controller. In some of these examples, evaporator outlet temperature is determined by various temperature sensors mounted to heat exchangers, openings, ducts and wherever else temperature knowledge is useful. In various embodiments, a controller monitors the temperature of fluid entering a heat exchanger and fluid exiting a heat exchanger. In some embodiments, a controller adjusts one or more components of the system 200 to address user input in view of the lowest temperature measured across multiple sensors. For example, if an occupant passenger temperature demand is lower than a driver temperature demand in a dual zone climate control configuration, the system 200 is adjusted to provide air for the cooler zone, and one or more heat exchangers such as PTC heaters warm the air for the remaining zones.

In some embodiments, a controller such as an EATC contains sensing, logic and control algorithms to allow automatic temperature control, with zone biasing to enhance human comfort perception. Zone biasing, in various embodiments, allows warmer temperature for the feet and cooler temperature toward the head or breath level simultaneously. In various embodiments, the EATC contains sensing, logic and control algorithms to sense the occupied zones and set temperature and distribution settings to provide comfort with minimal power consumption. Such behavior can be activated automatically, or via user selection of an economy mode. In some embodiments, outlet duct temperature settings and fan blower speed are manually controlled in addition to the EATC and Economy Mode settings. In some embodiments, the controller includes a thermostat and automatically controls one or more mechanisms to adjust the orientation of the to the fluid distribution ring 208 with respect HVAC shell 202.

In various embodiments, system 200 is preassembled. For example, in some embodiments, system 200 is shipped to a final assembly manufacturing plant for installation into a vehicle. In some of these examples, the system 200 is a module for assembly into a vehicle.

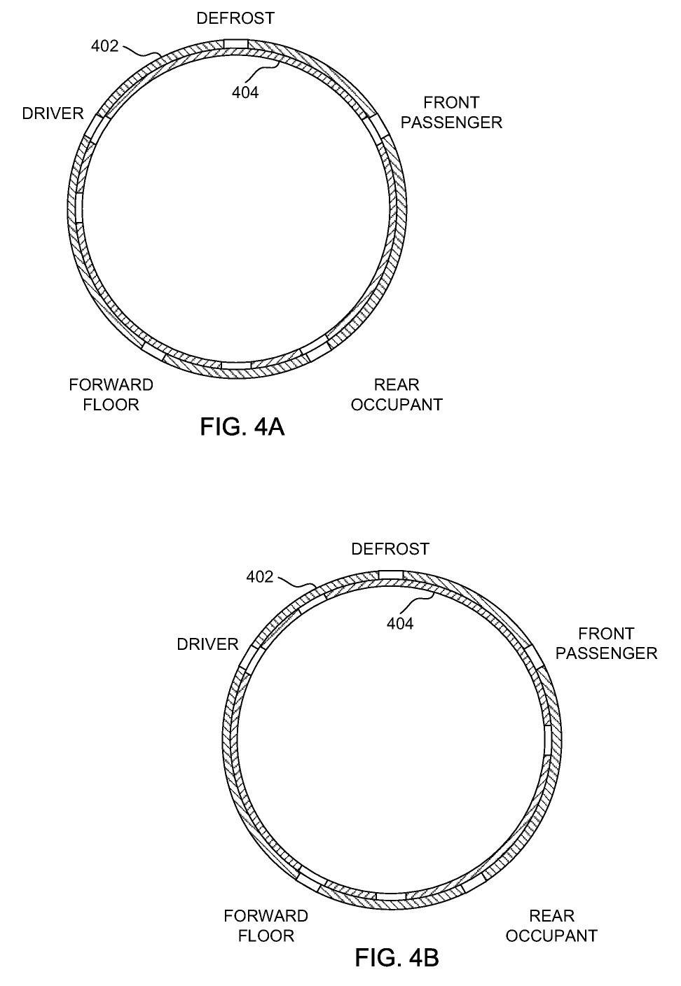

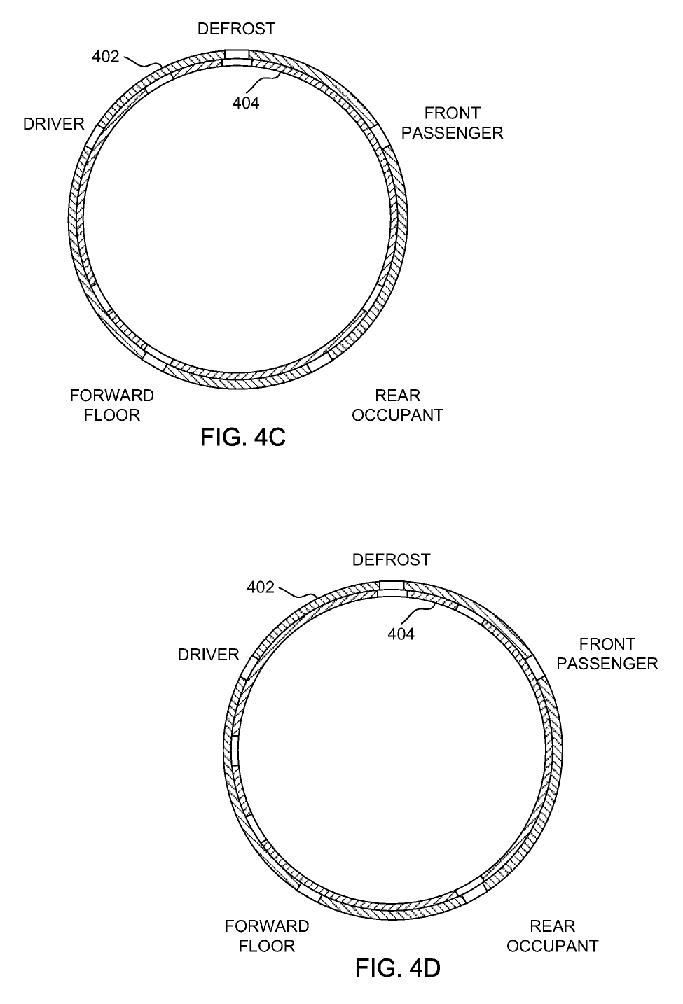

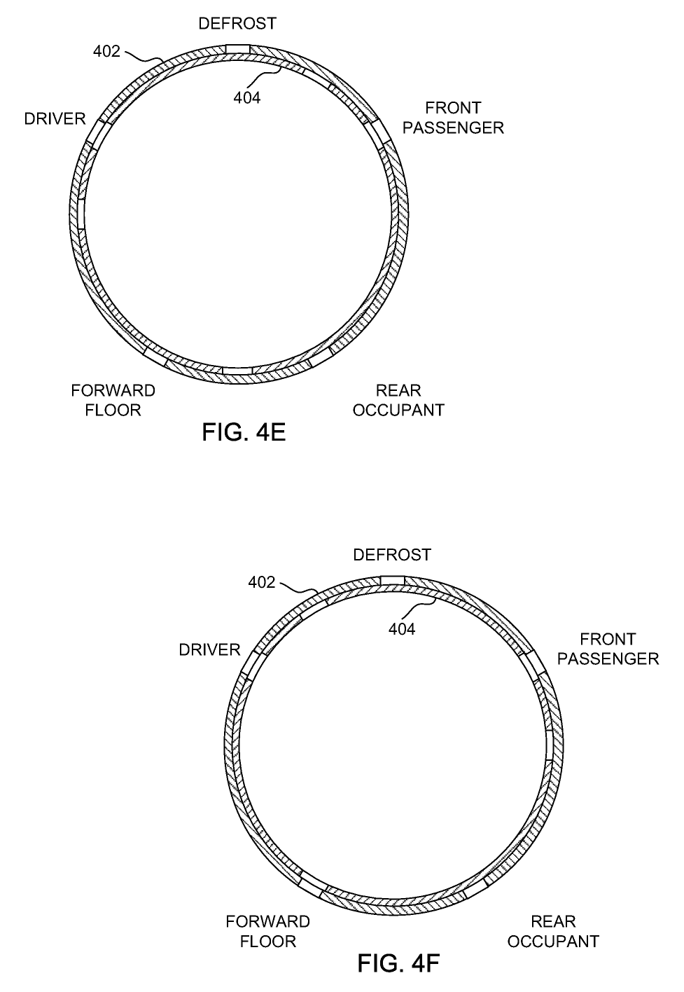

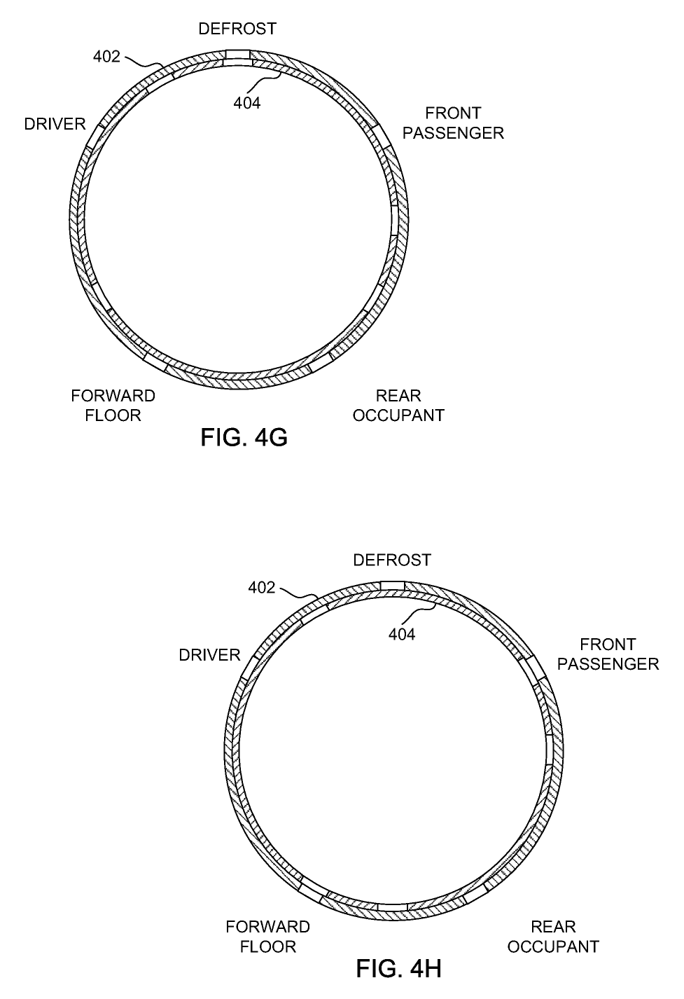

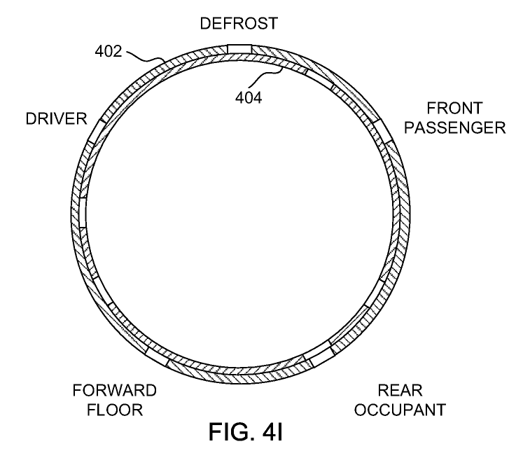

FIG. 4A-I show various cross sections of a shell and a fluid distribution unit, according to some embodiments. Various modes are contemplated. In a first mode, illustrated in FIG. 4A, the HVAC shell 402 and the fluid distribution ring 404 are aligned such that fluid is free to pass through a driver vent, a front passenger vent and a rear or aft occupant vent. For the purposes of explanation, the left side of the vehicle is termed the driver side, and the right side of the vehicle is termed the passenger side, but other coordinate systems are possible.

In a second mode, illustrated in FIG. 4B, the HVAC shell 402 and the fluid distribution ring 404 are aligned such that fluid is free to pass through a driver vent and a forward floor vent. The forward floor vent directs fluid toward the feet of a driver and a front seated passenger, but the present subject matter is not so limited. In various embodiments, the mode illustrated in FIG. 4B is a driver preferred mode.

In a third mode, illustrated in FIG. 4C, the HVAC shell 402 and the fluid distribution ring 404 are aligned such that fluid is free to pass through a defrost vent and to a forward floor vent. In various embodiments, the mode illustrated in FIG. 4C is a warm-up mode that can be engaged during warming and defrosting of the vehicle.

In a fourth mode, illustrated in FIG. 4D, the HVAC shell 402 and the fluid distribution ring 404 are aligned such that fluid is free to pass through a defrost vent and a rear occupant vent. In various embodiments, the mode illustrated in FIG. 4D could be used to defrost while providing heat for rear occupants, such as when a baby is seated in a rear seat.

In a fifth mode, illustrated in FIG. 4E, the HVAC shell 402 and the fluid distribution ring 404 are aligned such that fluid is free to pass through a driver vent and a front passenger vent.

In a sixth mode, illustrated in FIG. 4F, the HVAC shell 402 and the fluid distribution ring 404 are aligned such that fluid is free to pass through a driver vent, a front passenger vent and a forward floor vent.

In a seventh mode, illustrated in FIG. 4G, the HVAC shell 402 and the fluid distribution ring 404 are aligned such that fluid is free to pass through a defrost vent. In various embodiments, the mode illustrated in FIG. 4G is a maximum defrost mode, useful when visibility through glass is impaired by moisture.

In an eighth mode, illustrated in FIG. 4H, the HVAC shell 402 and the fluid distribution ring 404 are aligned such that fluid is free to pass through a forward floor vent and a front passenger vent. This mode is termed a passenger preferred mode. In various embodiments, the forward floor vent includes the forward floor around the front passenger area and the forward floor around the driver area, but the present subject matter is not so limited. In various embodiments a baffle in the floor vent ducting is included to direct all or a portion of the fluid flow to the driver side or the passenger side, for additional control of driver preferred and passenger preferred modes.

In a ninth mode, illustrated in FIG. 4I, the HVAC shell 402 and the fluid distribution ring 404 are aligned such that fluid is free to pass through a rear floor vent. A rear floor vent, in various embodiments, includes the rear floor area used by occupants sitting in the rear seat (e.g., 2nd row or 3rd row seating), but the present subject matter is not so limited. In some embodiments, a demist mode for windshield and side glass demisting is accomplished concurrently with other modes using a demist outlet, in-duct electric heater, and actuated door located in the HVAC shell 402 and ducted to the base of the defrost panel duct. In some embodiments, control of fluid outlet open/close position via a mode selection reduces the need for manually operated vents.

The assignment of the openings to areas or zones of a car are variable according to several embodiments. For example, sports cars having no rear occupants can direct the openings labeled “rear occupant” to another portion of a vehicle, such as individual floor outlets, to seats, or to a trunk space. These and other configurations are possible without departing from the present subject matter. Air distribution rings 404 having more or less apertures, or apertures at different locations are possible in various embodiments. HVAC shells 402 having more or less openings, or openings at different locations are possible in additional embodiments. In some embodiments, mass customization is possible by inventorying multiple air-distribution rings. For example, in some embodiments, a first air distribution ring having no aperture for alignment with the rear occupant opening is provided at a first price level, and a second air distribution ring having an aperture for alignment with the rear occupant opening is provided at a second price level higher than the first price level. The present subject matter's customization options are not limited to the rear occupant opening, and other openings can be withheld or provided according to pricing schemes or vehicle configuration in additional embodiments.

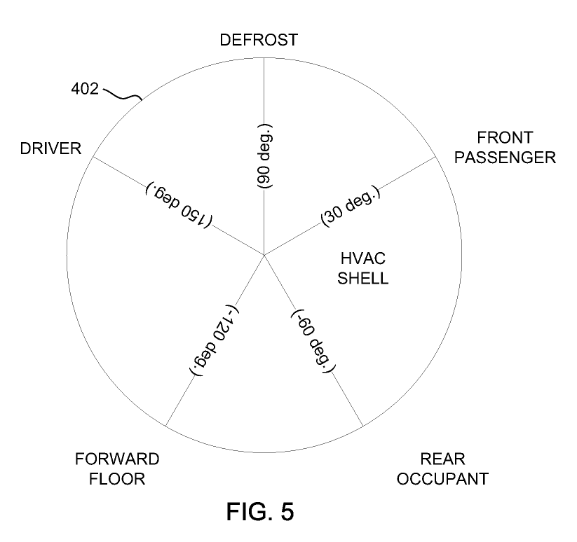

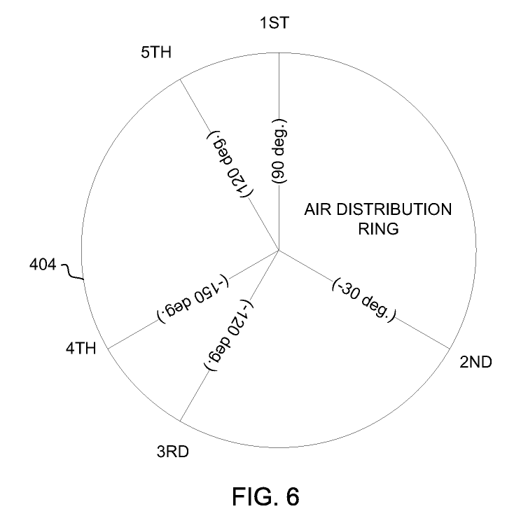

FIG. 5 is a diagram showing vent orientation in a shell, according to some embodiments. FIG. 6 is a diagram showing vent orientation in a fluid distribution ring, according to some embodiments. In various embodiments, the HVAC shell 402 includes a front passenger opening having a front passenger opening centerline, a rear occupant opening having a rear occupant opening centerline approximately 90 degrees from the front passenger opening centerline around the axis, a front passenger floor opening having a front passenger floor opening centerline approximately 150 degrees from the front passenger opening centerline around the axis, a driver opening having a driver opening centerline approximately 240 degrees from the front passenger opening centerline around the axis and a defrost opening having a defrost opening centerline approximately 300 degrees from front passenger opening centerline around the axis.

In additional embodiments, the fluid distribution ring 404 includes a first opening having a first opening centerline, a second opening having a second opening centerline approximately 120 degrees from the first opening centerline around the axis, a third opening having a third opening centerline approximately 210 degrees from the first opening centerline around the axis, a fourth opening having a fourth opening centerline approximately 240 degrees from the first opening centerline around the axis and a fifth opening having a fifth opening centerline approximately 330 degrees from first opening centerline around the axis.

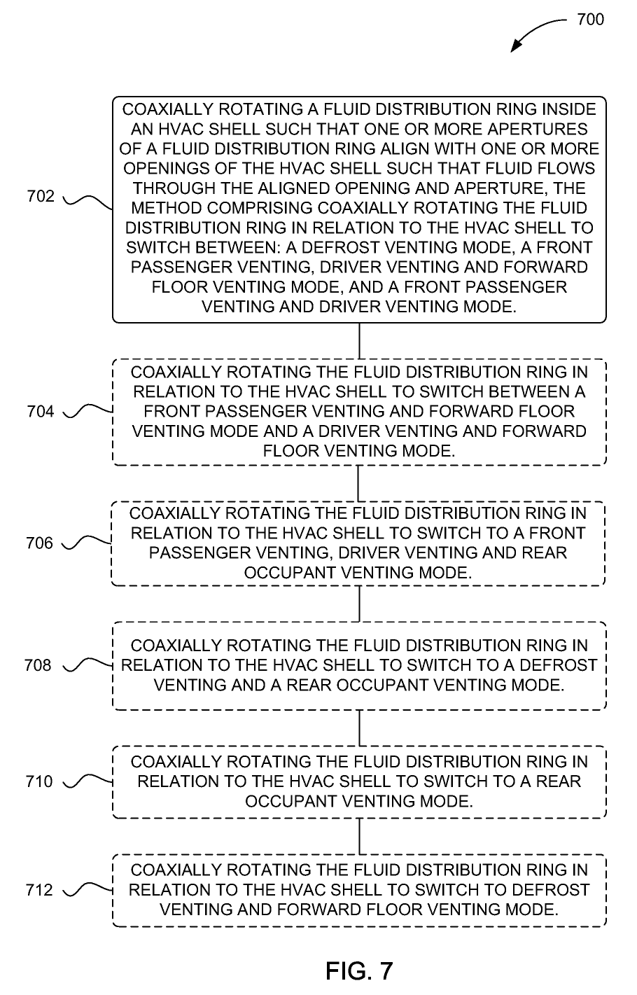

FIG. 7 illustrates a flow chart, according to some embodiments. At 702, the method 700 includes coaxially rotating a fluid distribution ring inside an HVAC shell such that one or more apertures of the fluid distribution ring align with one or more openings of the HVAC shell such that fluid flows through the aligned opening and aperture. The method 700 includes coaxially rotating the fluid distribution ring in relation to the HVAC shell to switch between a defrost venting mode, a front passenger venting, driver venting and forward floor venting mode and a front passenger venting and driver venting mode. At 704, the method 700 optionally includes coaxially rotating the fluid distribution ring in relation to the HVAC shell to switch between a front passenger venting and forward floor venting mode and a driver venting and forward floor venting mode. At 706, the method 700 optionally includes coaxially rotating the fluid distribution ring in relation to the HVAC shell to switch to a front passenger venting, a driver venting and a rear occupant venting mode. At 708, the method 700 optionally includes coaxially rotating the fluid distribution ring in relation to the HVAC shell to switch to a defrost venting and a rear occupant venting mode. At 710, the method 700 optionally includes coaxially rotating the fluid distribution ring in relation to the HVAC shell to switch to a rear occupant venting mode. At 712, the method 700 optionally includes coaxially rotating the fluid distribution ring in relation to the HVAC shell to switch to a defrost venting and a forward floor venting mode. One or more of the methods optionally includes coaxially rotating the fluid distribution ring with respect to the HVAC via a worm drive.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

What is claimed is:

1. Apparatus for a vehicle, comprising:
a heating, ventilation and air conditioning (“HVAC”) shell having a plurality of openings therein;
a fluid distribution ring mounted for coaxial rotary movement within the HVAC shell, the fluid distribution ring having one or more apertures therein to align with the plurality of openings in the shell to put the openings in fluid communication with an inner chamber; and
a mechanism coupled to the HVAC shell and the fluid distribution ring to rotate the fluid distribution ring relative to the HVAC shell between selected rotary positions to provide fluid flow paths through the inner chamber and those openings in the HVAC shell that are aligned with the one or more apertures in the fluid distribution ring.

2. The apparatus of claim 1, wherein the HVAC shell comprises a front passenger opening having a front passenger opening centerline, a rear occupant opening having a rear occupant opening centerline approximately 90 degrees from the front passenger opening centerline around an shell axis, a front passenger floor opening having a front passenger floor opening centerline approximately 150 degrees from the front passenger opening centerline around the shell axis, a driver opening having a driver opening centerline approximately 240 degrees from the front passenger opening centerline around the shell axis and a defrost opening having a defrost opening centerline approximately 300 degrees from the front passenger opening centerline around the shell axis.

3. The apparatus of claim 1, wherein the fluid distribution ring comprises a first opening having a first opening centerline, a second opening having a second opening centerline approximately 120 degrees from the first opening centerline around a ring axis, a third opening having a third opening centerline approximately 210 degrees from the first opening centerline around the ring axis, a fourth opening having a fourth opening centerline approximately 240 degrees from the first opening centerline around the ring axis and a fifth opening having a fifth opening centerline approximately 330 degrees from first opening centerline around the ring axis.

4. The apparatus of claim 1, further comprising a valve coupled to at least one of the plurality of openings in the HVAC shell to control the opening.

5. The apparatus of claim 1, further comprising a blower to force fluid from the inner chamber through those openings in the HVAC shell that are aligned with the one or more apertures in the fluid distribution ring.

6. The apparatus of claim 1, further comprising a heat exchanger operatively coupled to alter a temperature of fluid passing through those openings in the HVAC shell that are aligned with the one or more apertures in the fluid distribution ring.

7. The apparatus of claim 6, further comprising a second heat exchanger coupled to further contact fluid passing through those openings in the HVAC shell that are aligned with the one or more apertures in the fluid distribution ring.

8. The apparatus of claim 7, wherein the second heat exchanger comprises a positive temperature coefficient heat exchanger.

9. The apparatus of claim 6, further comprising a heat exchanger housing coupled to the heat exchanger to constrain fluid flow from an inlet of the heat exchanger housing to the inner chamber.

10. The apparatus of claim 9, wherein the heat exchanger housing is mounted to a vehicle and the inlet defines a passage leading to an interior cabin of the vehicle.

11. The apparatus of claim 10, wherein the inlet further defines a passage leading to the exterior of the vehicle.

12. Method comprising coaxially rotating a fluid distribution ring inside an HVAC shell such that one or more apertures of a fluid distribution ring align with one or more openings of the HVAC shell such that fluid flows through the aligned opening and aperture, the method comprising coaxially rotating the fluid distribution ring in relation to the HVAC shell to switch between:
a defrost venting mode;
a front passenger venting, driver venting and forward floor venting mode; and
a front passenger venting and driver venting mode.

13. The method of claim 12, further comprising coaxially rotating the fluid distribution ring in relation to the HVAC shell to switch between a front passenger venting and forward floor venting mode and a driver venting and forward floor venting mode.

14. The method of claim 12, further comprising coaxially rotating the fluid distribution ring in relation to the HVAC shell to switch to a front passenger venting, a driver venting and a rear occupant venting mode.

15. The method of claim 12, further comprising coaxially rotating the fluid distribution ring in relation to the HVAC shell to switch to a defrost venting and forward floor venting mode.

16. The method of claim 12, further comprising coaxially rotating the fluid distribution ring in relation to the HVAC shell to switch to a defrost venting and a rear occupant venting mode.

17. The method of claim 12, further comprising coaxially rotating the fluid distribution ring in relation to the HVAC shell to switch to a rear occupant venting mode.

18. The method of claim 12, further comprising coaxially rotating the fluid distribution ring with respect to the HVAC via a worm drive.

19. Apparatus, comprising:
means for rotating a fluid distribution ring with respect to an HVAC shell to switch between:
a defrost venting mode;
a defrost venting and forward floor venting mode;
a front passenger venting, driver venting and forward floor venting mode; and
a front passenger venting and driver venting mode; and
a blower coupled to the means to force fluid through the means.

20. The apparatus of claim 19, wherein the means and the blower are part of a pre-assembled module to be installed in a vehicle.
